(19) United States
(12) Patent Application Publication
(10) Pub. No.: US 2025/0356484 A1
(43) Pub. Date: Nov. 20, 2025

(54) APPARATUS AND METHOD FOR SEGMENTATION OF MEDICAL IMAGE

(71) Applicant: Dongguk University Industry-Academic Cooperation Foundation, Seoul (KR)

(72) Inventors: Jihie KIM, Seoul (KR); Sung Min KANG, Seoul (KR)

(21) Appl. No.: 19/201,173

(22) Filed: May 7, 2025

(30) Foreign Application Priority Data
May 14, 2024 (KR) 10-2024-0063117

(51) Int. Cl. G06T 7/00; G06T 7/11; G06T 7/143

(52) U.S. Cl. CPC G06T 7/0012; G06T 7/11; G06T 7/143; G06T 2207/20008; G06T 2207/20081

(57) ABSTRACT

An embodiment relates to a medical image segmentation technique, and more particularly, to an anatomy-based medical image segmentation apparatus and method specialized in segmentation of medical images. Accuracy of segmenting organs in a medical image including regions with complex or ambiguous boundaries can be improved significantly by using a Diffusion Transformer Segmentation (DTS) model. The DTS model may establish a more accurate diagnosis and treatment plan in the field of medical image application by capturing spatial relationships within the anatomical structure and emphasizing object boundaries between adjacent structures or backgrounds. In addition, the embodiment may increase efficiency by providing models of various formats such as CT, MRI, and lesion images, and contribute to ultimate advancement in the medical image analysis by promoting future research and development of medical imaging software in medical imaging practice.

### CROSS REFERENCE TO RELATED APPLICATION

The present application claims priority to Korean Patent Application No. 10-2024-0063117, filed May 14, 2024, the entire contents of which are incorporated here for all purposes by this reference.

### BACKGROUND OF THE INVENTION

### Field of the Invention

The present invention relates to a medical image segmentation technique, and more particularly, to an anatomy-based medical image segmentation apparatus and method specialized in segmentation of medical images.

### Background of the Related Art

Medical images acquired from equipment of computed tomography (CT), magnetic resonance imaging (MRI), and ultrasound frequently contain noises generated during acquisition or processing of the images. In addition, as artifacts such as motion artifacts, metal artifacts, and aliasing artifacts may degrade image quality, they make accurate segmentation more difficult. Since human anatomies vary in the shape, size, and texture, even the same anatomical structures have a difference in the shape of an image. Since inconsistency occurs in the shape of an image due to change of imaging protocols, such as the difference in the parameters and imaging artifacts, the segmentation task can be more complicated. In addition, when there is a pathological phenomenon such as a tumor, a lesion, or an abnormality, boundaries of organs become more obscure, and additional difficulties may occur in segmentation.

The background technique of the present invention is disclosed in Korean Laid-opened Patent No. 10-2023-0165284.

### SUMMARY OF THE INVENTION

The present invention provides a medical image segmentation apparatus and method. It can be expected that the Diffusion Transformer Segmentation (DTS) model of the present invention will significantly improve accuracy of segmenting organs in a region with complex or ambiguous boundaries in a medical image. In addition, an object of the present invention is to overcome the essential problems of existing segmentation models and provide a more accurate segmentation method through anatomy-based learning such as neighboring label smoothing or reverse boundary attention.

The technical problems to be solved by the present invention are not limited to the technical problems mentioned above, and unmentioned other technical problems can be clearly understood by those skilled in the art from the following descriptions.

To accomplish the above object, according to one aspect of the present invention, there is provided a medical image segmentation apparatus and method.

A medical image segmentation apparatus according to an embodiment of the present invention may comprise: an image input unit for inputting a medical image; a processing unit for embedding the input image into two encoders; a prediction unit for inputting the embedded image into a decoder to predict a global feature map; and a segmentation unit for segmenting the predicted feature region into regions of accurate organ locations.

### BRIEF DESCRIPTION OF THE DRAWINGS

FIG. 1 is a view for explaining a medical image segmentation apparatus according to an embodiment of the present invention.

FIGS. 2 to 6 are views showing the structure of a medical image segmentation apparatus according to an embodiment of the present invention.

FIG. 7 is a view for explaining a medical image segmentation apparatus algorithm according to an embodiment of the present invention.

FIGS. 8 to 14 are views showing experiment results of a medical image segmentation apparatus according to an embodiment of the present invention.

FIG. 15 is a view showing a computing device implementing a descriptor generation method and device according to an embodiment of the present invention.

### DETAILED DESCRIPTION OF THE PREFERRED EMBODIMENT

The present invention may have various modifications and various embodiments, and specific embodiments are illustrated in the drawings and described in detail through detailed descriptions. However, this is not intended to limit the present invention to the specific embodiments, and it should be understood that it includes all modifications, equivalents, and substitutes included in the spirit and technical scope of the present invention. When it is determined in describing the present invention that a detailed description of a related known technology may unnecessarily obscure the gist of the present invention, the detailed description will be omitted. In addition, singular expressions used in the specification and claims should be construed to generally mean “one or more” unless mentioned otherwise.

Throughout the specification, when a part is said to be “connected (coupled, contacted, joined)” to another part, this includes cases where they are “indirectly connected” with intervention of other members in between, as well as cases where they are “directly connected”. In addition, when a part is said to “include” a certain component, this does not mean that other components are excluded, but that other components may be further provided, unless otherwise stated specifically.

The terms used in this specification are used only to describe specific embodiments and not to limit the present invention. Singular expressions include plural expressions unless the context clearly indicates otherwise. In this specification, it should be understood that the terms “include”, “have”, and the like are intended to specify the presence of features, numbers, steps, operations, components, parts, or combinations thereof described in the specification, not to exclude in advance the possibility of presence or addition of one or more other features, numbers, steps, operations, components, parts, or combinations thereof.

Hereinafter, the present invention will be described with reference to the accompanying drawings. However, the present invention may be implemented in various different forms and is not limited to the embodiments described herein. In addition, in order to clearly describe the present invention in the drawings, parts that are not related to the description are omitted, and similar drawing reference numerals are assigned to similar parts throughout the specification.

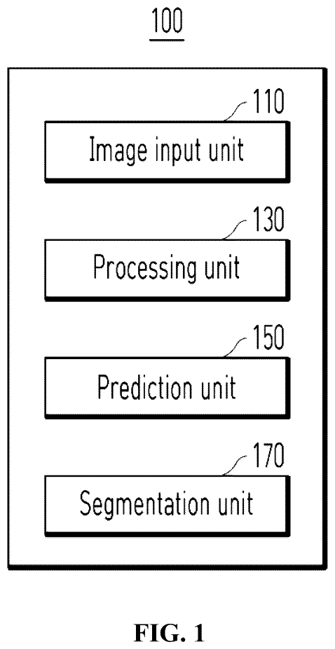

FIG. 1 is a view for explaining a medical image segmentation apparatus according to an embodiment of the present invention.

Referring to FIG. 1, the medical image segmentation apparatus includes an image input unit 110, a processing unit 130, a prediction unit 150, and a segmentation unit 170.

The image input unit 110 inputs a medical image into the medical image segmentation apparatus. The medical images may include CT, MRI, and lesion image data and labels.

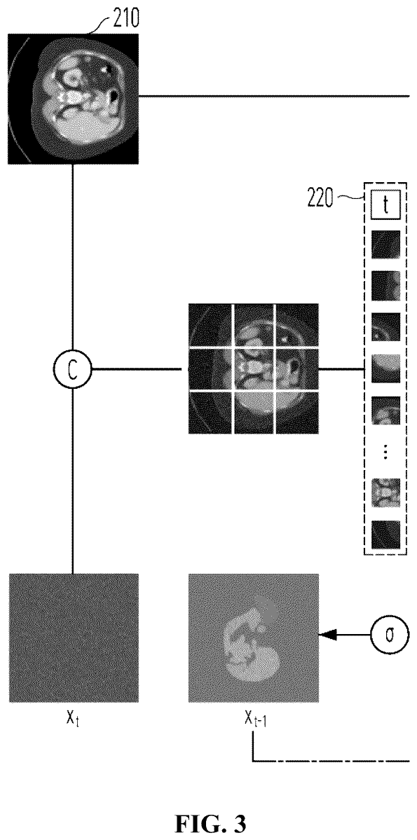

The processing unit 130 performs an operation of embedding the input image into two encoders. The processing unit 130 calculates the input image and a pre-labeled image, divides the image in units of patches, and performs embedding. The medical image is embedded in a first feature encoder to be focused on image representation learning, and the image and the label-processed image are added in the encoder of the present invention to be embedded. Specific matters will be described in detail in FIG. 3.

The processing unit 130 may effectively encode human anatomical information in an image by self-supervised learning (SSL). The present invention may include three proxy tasks for learning comprehensive semantic representations within a masked image without using labels.

The self-supervised learning (SSL) performs contrastive learning of improving the ability of distinguishing between different samples with hidden feature representations by encoding a masked image, masked location prediction of predicting the location of a sample, and partial reconstruct prediction of learning feature representations by reconstructing a masked patch area of each sub-volume.

The contrastive learning derives positive samples from the same input and expresses semantic similarities. In particular, latent feature representations originated from the same input are considered as positive samples. Feature representations of a unique image within a mini-batch are used to generate negative samples for contrastive learning. These negative samples empathize the differences between feature representations to allow the model to learn and distinguish between various inputs.

$${ℒ}_{CL} = - log \frac{exp ( \frac{sim ( {x}_{i} , {x}_{j} )}{t} )}{{\sum }_{k}^{2 N} {1}_{k \neq i , j} exp ( \frac{sim ( {x}_{i} , {x}_{j} )}{t} )} \qquad [ Equation 1 ]$$

In Equation 1, tis a temperature parameter that controls smoothness of distribution. 1 is an index that evaluates as 1 iff k≠i. x denotes a feature representation extracted by the encoder. sim(xᵢ, xᵢ) denotes similarities between representations of positive samples, and sim(xᵢ, xₖ) denotes similarities between representations of negative samples.

The masked location prediction uses a 9-dimensional probability vector to represent a predicted number for the n-th sub-volume, denoted as \hat{v}ₙ, as a masked patch number in [0, 1, . . . , 8]. When target v is given, a cross-entropy loss is used for the task of predicting the number.

$${ℒ}_{Loc} = - \frac{1}{R} {\sum }_{n = 1}^{R} {v}_{n} log ( {\hat{v}}_{n} ) \qquad [ Equation 2 ]$$

In equation 2, R denotes the number of sub-volumes, and vₙ is expressed as a one-hot vector.

In the partial reconstruct prediction, the masked image modeling method learns feature representation by reconstructing all pixel values of a masked region through the decoder of image. Considering complex characteristics of medical images, a multi-dimensional decoder is required for thorough image reconstruction. The partial reconstruct loss is defined as L₂ distance between the reconstructed region and the masked voxels of a target region.

$${ℒ}_{Rec} = - \frac{1}{\vert \hat{R} \vert} {\sum }_{r ϵ \hat{R}} {‖ {y}_{r} - {\hat{y}}_{r} ‖}_{2} \qquad [ Equation 3 ]$$

In Equation 3, \hat{R} is a subset of a sub-volume of the target region, |\hat{R}| is the number of related sub-volumes, and yᵣ and ŷᵣ denote a predicted value and an input value, respectively.

The present invention minimizes a total objective loss function that combines losses of the partial reconstruct prediction, the masked location prediction, and the contrastive learning as shown in Equation 4.

$${ℒ}_{total} = {ℒ}_{Rec} + {λ}_{1} {ℒ}_{Loc} + {λ}_{2} {ℒ}_{CL} \qquad [ Equation 4 ]$$

In equation 4, λ₁ and λ₂ are set to 0.1 and 0.01 as a result of verification experiments.

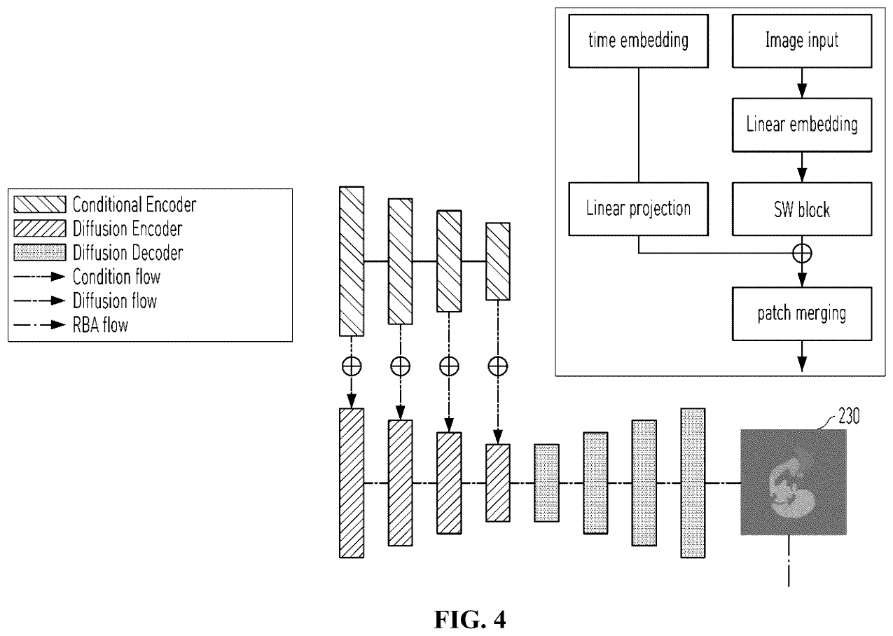

The prediction unit 150 inputs an embedded image into the decoder to predict a global feature map. The prediction unit 150 primarily predicts a global feature map through the decoder. The process of generating a global feature map will be described in detail in FIG. 4.

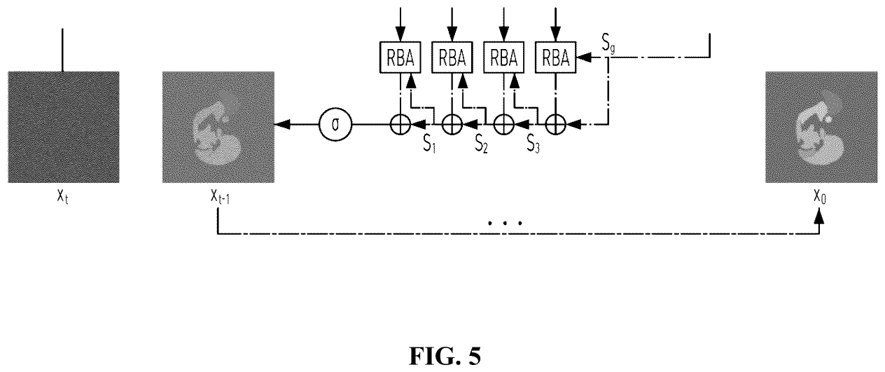

The segmentation unit 170 segments the predicted region into regions of accurate organ locations. At this point, the segmentation unit 170 pays attention to incorrectly predicted regions using a Reverse Boundary Attention (RBA) module. The RBA module will be described in detail in FIG. 5. The segmentation unit 170 applies a k-neighbor label smoothing algorithm to medical data of body parts such as the abdomen, brain, and the like having a structural location in a compact space. The k-neighbor label smoothing algorithm utilizes relative locations of organs by smoothing labels of k neighbors for a given class or organ. In a complicated multi-class (k>2) situation like this case, the present invention has an advantage when they have positional relationship therebetween. Anatomically, the positional relationship means relative positional relationship of organs. The equation of k-neighbor label smoothing (k-NLS) is as shown below in Equation 4.

$${d}_{t} = \{ {d}_{xyz} \vert x , y , z ϵ N , x < W , y < H , z < D \} \qquad [ Equation 4 ]$$

In Equation 4, the distance is calculated for each channel as the distance between an arbitrary point and the center of an i-th class.

$${y}_{t}^{k - NLS} = α \vert {y}_{t} - \frac{1}{{d}_{t} + ϵ} \vert \qquad [ Equation 5 ]$$

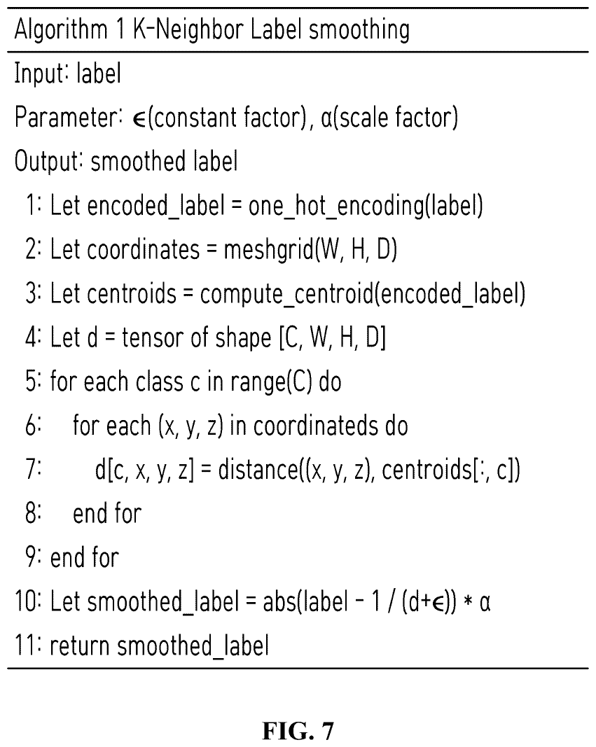

Here, yₜ is “1” in the case of a target class and “0” in the case of remaining classes, a is a label smoothing scale factor, ϵ is 1e⁻⁶, which is constant to avoid division by 0, and d_{x,y,z}={d₀, d₁, . . . , dᵢ|i=k} is a set of centroids between each pixel, and the class. The scale factor denoted as a determines the degree of smoothing applied to a predicted probability. The pseudo-code applied to the present invention is described in detail in FIG. 7.

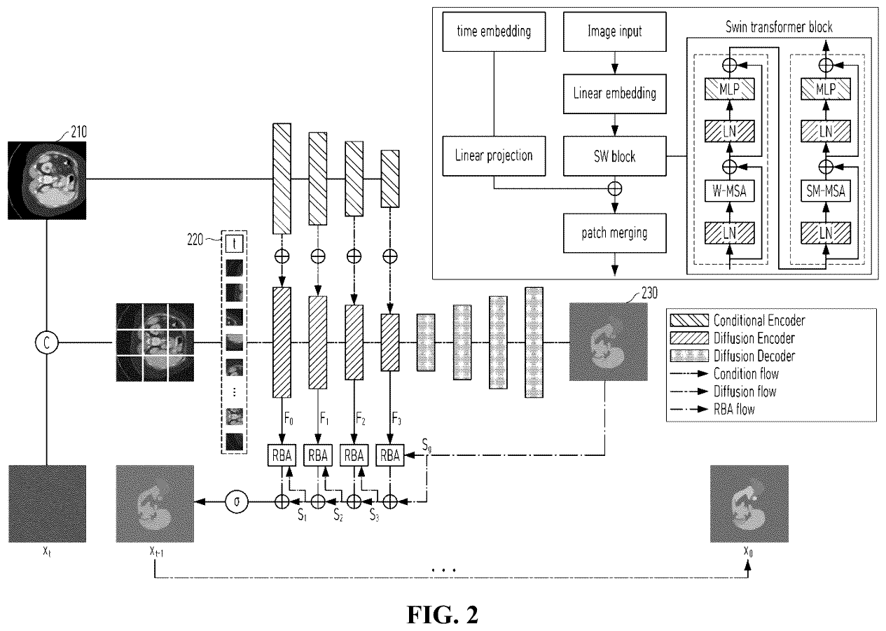

FIGS. 2 to 6 are views showing the structure of a medical image segmentation apparatus according to an embodiment of the present invention.

Referring to FIG. 2, a diffusion model is configured of a diffusion process and a noise removal process. In the diffusion process, Gaussian noise is gradually added to the segmentation label over a series of steps t. The process does not include a neural network. The reverse process trains a neural network to reverse the noise in order to recover the original data. In this case, the reverse process is parameterized by θ.

$${p}_{θ} ( {x}_{0 : t - 1} \vert {x}_{t} ) := {\prod }_{t = 1}^{t} {p}_{θ} ( {x}_{t - 1} \vert {x}_{t} ) \qquad [ Equation 6 ]$$

$${p}_{θ} ( {x}_{t - 1} \vert {x}_{t} ) := 𝒩 ( {x}_{t - 1} ; {μ}_{θ} ( {x}_{t} , t ) , {\sum }_{θ} ( {x}_{t} , t ) ) \qquad [ Equation 7 ]$$

Distribution p_{θ}(xₜ) is specified as [symbol] (xₜ; 0, I_{n×n}) from the diffusion process, and in the equations 6 and 7, I denotes a raw image assumed to be an n×n matrix. Thereafter, the reverse process transforms the latent variable distribution p_{θ}(xₜ) (Gaussian noise image) into a data distribution p_{θ}(x₀) (final segmentation map).

Referring to FIG. 3, the image segmentation apparatus inputs an original image 210. Thereafter, after concatenating the original input image and a ground truth mask image labeled by a medical staff and dividing the image in units of patches by performing patch partition 220, embedding is performed as tokens having a sequence.

Referring to FIG. 4, the present invention learns the global dependency between patches by performing self-attention using a diffusion encoder of a swin transformer. Here, the present invention adds weights learned from the existing CT image feature representation through pre-learning of a conditional encoder for better understanding of the features of the input image. Thereafter, the present invention generates a global feature map 230 through a diffusion decoder.

Referring to FIG. 5, RBAs perform reverse attention by focusing on non-object regions through recognition of image boundary portions to easily know boundaries of incorrectly predicted objects. The present invention creates an xₜ−1 image from an xₜ image added with Gaussian noise and generates a final predicted image x₀ by repeatedly performing a noise removal process.

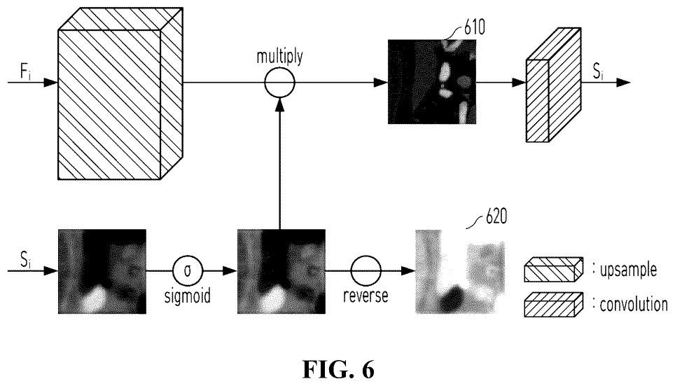

Referring to FIG. 6, the reverse boundary attention (RBA) method improves prediction of the segmentation model by gradually capturing and designating regions that may have been ambiguous initially. Therefore, the present invention removes previously estimated prediction regions from a high-level output function where existing estimated values are up-sampled in deeper layers, sequentially explores specific information including corresponding regions and boundaries, and finally, gradually improves prediction of the segmentation model. The present invention obtains a reverse attention RAᵢ 610 by multiplying high-level outputs {Fᵢ, i=1, 2, 3, 4} by the weights Rᵢ 620 of the reverse attention.

$${RA}_{i} = {F}_{i} ⊙ {R}_{i} \qquad [ Equation 8 ]$$

$${R}_{i} = ⊖ ( σ ( 𝒰 ( {S}_{i + 1} ) ) ) \qquad [ Equation 9 ]$$

In Equations 8 and 9, when U(·), σ(·), and θ(·) are up-sampling, sigmoid, and reverse functions, the reverse function removes the matrix, and this is 1 in all elements. The reverse attention weight RAᵢ 610 passes through two convolutional layers together with normalization, and finally, a reverse boundary attention Si+1 is obtained as shown in Equation 10.

$${S}_{i + 1} = {L}_{conv} ( {RA}_{i} ) \qquad [ Equation 10 ]$$

In the noise removal process, when the input of the encoder is a sub-volume [symbol] ϵR^{H×W'D×S}, the dimension of a 3D token with a patch resolution of (H′, W′, D′) is H′×W′×D′×S. The patch partition layer generates a 3D token sequence of a

$$\frac{H}{H ′} \times \frac{W}{W ′} \times \frac{D}{D ′}$$

size projected into a C-dimensional space through an embedding layer. For efficient modeling of token interactions, the input volume is partitioned into non-overlapping windows, and local self-attention is calculated in each region. In particular, in layer l, the 3D tokens are evenly divided into windows using windows of a ┌H′/M┐×┌W′/M┐×┌D′/M┐ size

In the next layer l+1, the divided windows are moved in units

$$( ⌊ \frac{M}{2} ⌋ , ⌊ \frac{M}{2} ⌋ , ⌊ \frac{M}{2} ⌋ )$$

voxels. The output of the swin transformer encoder block in layers l and l+1 is as shown in Equation 11.

$${\hat{z}}^{l} = W - MSA ( LN ( {z}^{l - 1} ) ) + {z}^{l - 1} \qquad [ Equation 11 ]$$

$${z}^{l} = MLP ( LN ( {\hat{z}}^{l} ) ) + {\hat{z}}^{l}$$

$${\hat{z}}^{l + 1} = SW - MSA ( LN ( {z}^{l} ) ) + {z}^{l}$$

$${z}^{l + 1} = MLP ( LN ( {\hat{z}}^{l + 1} ) ) + {\hat{z}}^{l + 1}$$

Here, W-MSA and SW-MSA are windows that divide the regular and multi-head self-attention modules, respectively. \hat{z}^{l} and \hat{z}^{l+1} are outputs of W-MSA and SW-MSA, and LN and MLP represent hierarchical normalization and multilayer perceptron.

In addition, the present invention calculates self-attention including a relative position bias as shown in equation 12.

$$Attention ( Q , K , V ) = Soft max ( \frac{{QT}^{T}}{\sqrt{d}} ) V \qquad [ Equation 12 ]$$

In Equation 12, Q K, V∈R^{M}^{³}^{×d} represent query, key, and value, respectively, and d is the size of the query and the key. The present invention uses a patch merging layer between all stages to lower the resolution by two times. In stage 1, the number of tokens as

$$\frac{H}{2} \times \frac{W}{2} \times \frac{D}{2}$$

maintained by the linear embedding layer and the transformer block. In stages 2, 3, and 4, the same process is repeated with resolutions of

$$\frac{H}{4} \times \frac{W}{4} \times \frac{D}{4} , \frac{H}{8} \times \frac{W}{8} \times \frac{D}{8} , and \frac{H}{16} \times \frac{W}{16} \times \frac{D}{16} ,$$

respectively.

A CNN-based decoder through a skip connection is connected to the encoder. At each stage of Fᵢ(iϵ{0, 1, 2, 3}) known as the bottleneck (i=4), the output sequence is captured, and the feature size is adjusted to

$$\frac{H}{{2}^{i}} \times \frac{W}{{2}^{i}} \times \frac{D}{{2}^{i}} .$$

The representation extracted at each stage is transferred to the residual block configured of 3×3×3 convolutional layers through normalization. Thereafter, the functions processed at each stage are up-sampled using a deconvolutional layer and connected to functions processed at the previous stages. The segmentation task combines the functions processed in the input and output volumes of the encoder of the swin transformer. The connected information is transferred through the residual block and the final 1×1×1 convolutional layer, and an appropriate activation function (Softmax) is applied to calculate a segmentation probability. At this point, when conditional diffusion segmentation is applied, noise xₜ, time embedding t, and conditional image I encoded as Î_{c} are integrated.

$${\hat{x}}_{0} = DTS ( concat ( {x}_{t} , I ) , t , {\hat{I}}_{c} ) \qquad [ Equation 13 ]$$

In Equation 13, DTS denotes a new diffusion transformer segmentation model, which replaces the existing noise removal U-Net.

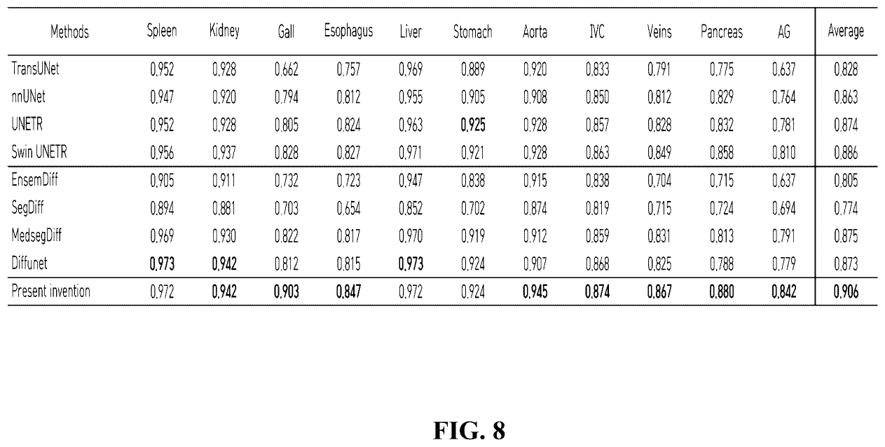

FIGS. 8 to 14 are views showing experiment results of a medical image segmentation apparatus according to an embodiment of the present invention. The quantitative results show performance on the image datasets of CTs, MRIs, and skin lesions. In the case of BTCV dataset, the proposed model shows high performance on smaller organs although similar to those of diffusion segmentation models, and has performance higher than those of previous studies on the MRI and skin lesion images.

Referring to FIG. 8, FIG. 8 shows a result of BTCV challenge for multi-organ segmentation. The upper and lower parts of FIG. 8 show non-diffusion and diffusion-based segmentation models, respectively.

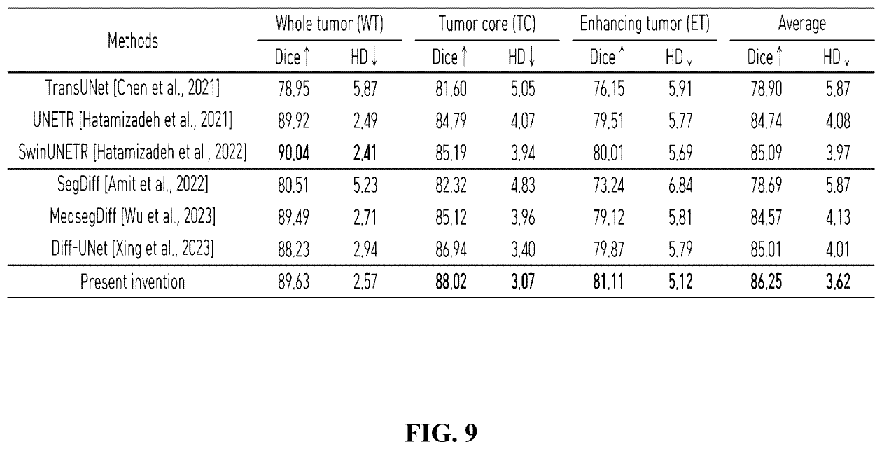

Referring to FIG. 9, FIG. 9 is a quantitative result of BraTS dataset. Here, the loss function integrates DICE loss [Sudre et al., 2017], BCE loss, and MSE loss. In the case of BTCV, learning utilizes randomly cropped images with a resolution of 96×96 and a batch size of 4 per GPU. However, in the case of BraTS, the random crop size is set to 128×128, and the batch size is 2 per GPU. The present invention adopts random flip, rotation, strength scaling, and shift for data augmentation, and sets the number of diffusion steps to 1,000, and the sliding window overlapping ratio until the final prediction is 0.8.

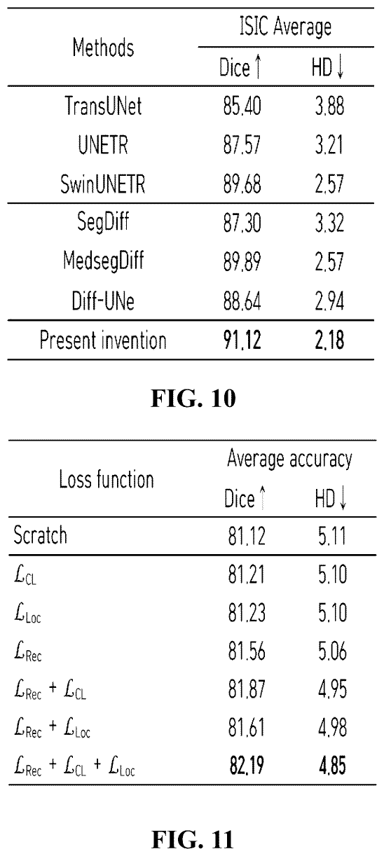

Referring to FIG. 10, the overall performance test results of the non-diffusion and diffusion-based segmentation models on the ISIC dataset are shown. Here, the average accuracy of Dice and HD95 scores shows high performance reaching 92.12 and 2.18, respectively. In this dataset, k-neighbor label smoothing may not be applied since there is only a single label without a structural position relationship between labels.

Referring to FIG. 11, the present invention performs a comprehensive ablation experiment on the BTCV dataset to evaluate the efficiency of self-supervised learning. FIG. 11 shows a result of using a specific setting to calculate the loss of the experiment. The experiment includes three loss functions including L_{Rec} (partial reconstruct prediction), L_{Loc} (masked location prediction), and L_{CL} (contrastive learning). In particular, L_{Rec} is learned on the basis of pixels, L_{Loc} is learned on the basis of regions, and L_{CL} is learned at the augmented sample level focusing on the contrastive learning. As can be seen from the result of the experiment, L_{Rec} performs an important function in understanding meaningful representation learning in medical images.

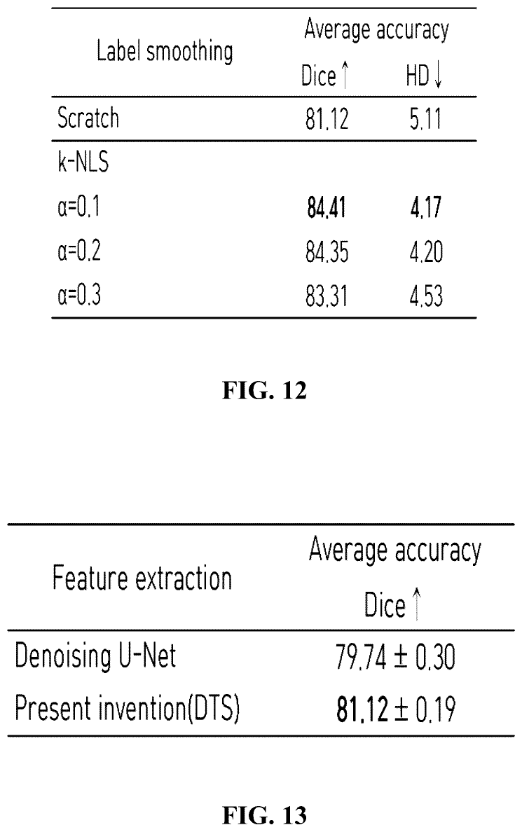

Referring to FIG. 12, the present invention continues exploration of model improvements and investigates ablation studies on the BTCV dataset, and particularly focuses on the effect of scale factor a on the performance of k-neighbor label smoothing. In general, label smoothing prevents model overfitting and improves generalization performance. The scale factor denoted as a in Equation 5 determines the degree of smoothing applied to a predicted probability. The present invention features a wider and smoother probability distribution as an effect of increasing a value, and the result of Dice is 3.29 (%), which is superior to existing baseline models.

Referring to FIG. 13, the scratch model uses a hybrid model that combines existing dominant CNN-based noise removal U-Net and the swin transformer encoder, of which the effective is proven in various fields such as natural language and image processing. The model with the swin transformer encoder improves segmentation by capturing long-term contextual meaning in the extraction of features of images.

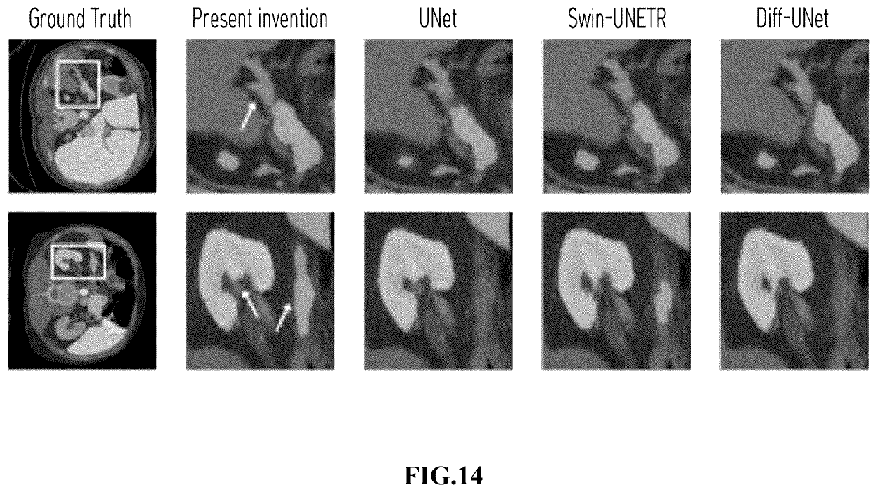

Referring to FIG. 14, shows qualitative results for the BTCV dataset. When the indicated square box in the ground truth data of FIG. 14 is enlarged, it can be seen that representation of a corresponding part is smoothly segmented, and segmentation in small organs shows performance close to the representation of the ground truth data through learning of feature representation.

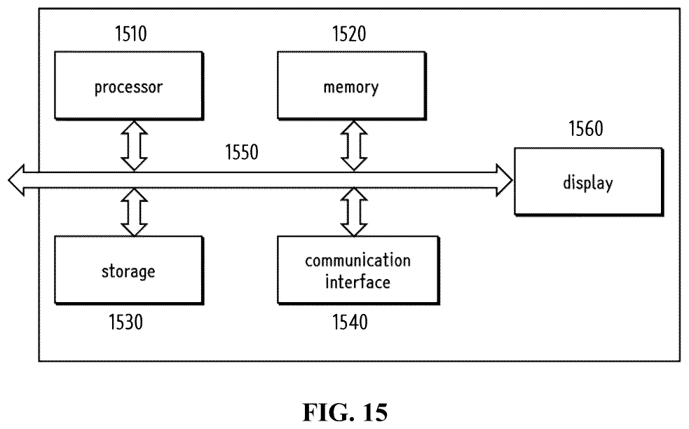

Referring to FIG. 15, shows a computing device implementing a descriptor generation method and device according to an embodiment of the present invention.

The embodiments of the present invention described in FIGS. 1 to 6 may be implemented as a computing device 1500 operating by at least one processor.

The computing device 1500 may include a processor 1510, a memory 1520, a storage 1530, a communication interface 1540, a system interconnect 1550, and a display 1560.

The processor 1510 includes a central processing unit (CPU), a microprocessor unit (MPU), a micro controller unit (MCU), a graphic processing unit (GPU), and an application processing unit (APU).

The memory 1520 interacts with the processor 1510 perform a function of storing data and quickly accessing necessary information so that the program may be executed efficiently. The memory 1520 includes at least one among a register, a cache memory, a main memory, a read-only memory, a virtual memory, and a nonvolatile memory.

The storage 1530 performs a function of permanently storing and managing data. The storage is used to preserve data even after the computing system is turned off or rebooted, and store operating systems, applications, user files, and the like. The storage 1530 includes at least one among a hard disk drive (HDD), a solid-state drive (SSD), an optical disk, a network storage, and a cloud storage.

The communication interface 1540 provides a path for transmitting and receiving data between various devices inside and outside the computing system. The communication interface 1540 may support at least one communication method among Universal Serial Bus (USB), Peripheral Component Interconnect Express (PCIe), Serial ATA (SATA), Ethernet, Wi-Fi, Thunderbolt, and High-Definition Multimedia Interface (HDMI).

The system interconnect 1550 performs a function of transmitting and receiving data and signals among various components within the computing system. The system interconnect 750 may support at least one method among a bus, a point-to-point interconnect, a crossbar switch, and a network-on-chip (NoC).

The display 1560 is an output device of the computing system and performs a function of providing visual information to users.

According to the configuration described above, a program according to an embodiment of the present invention is executed based on instructions executed by the processor 1510, and may be stored in the memory 1520 or the storage 1530.

The medical image segmentation method described above may be implemented as a computer-readable code on a computer-readable medium. The computer-readable recording medium may be, for example, a portable recording medium (CD, DVD, Blu-ray disc, USB storage device, portable hard disk) or a fixed recording medium (ROM, RAM, computer-attached hard disk). Computer programs recorded on the computer-readable recording medium may be transmitted to other computing devices through a network such as the Internet and installed in the other computing devices and therefore may be used in other computing devices.

As described above, although all the components constituting the embodiments of the present invention have been described to be combined into one or operating in combination, the present invention is not necessarily limited to the embodiments. That is, within the scope of the present invention, all the components may be selectively combined into one or more to operate.

Although the operations are illustrated in the drawings in a particular order, it should not be understood that the operations should be performed in the particular order illustrated in the drawings or performed in a sequential order or all illustrated operations should be performed to obtain a desired result. In a specific situation, multitasking and parallel processing may be advantageous. Moreover, it should not be understood that separation of various components is necessarily required in the embodiments described above, and it should be understood that the program components and system described above may generally be integrated together as a single software product or packaged as a plurality of software products.

The present invention has been described above with reference to the embodiments thereof. Those skilled in the art will understand that the present invention can be implemented in modified forms without departing from the essential characteristics of the present invention. Therefore, the disclosed embodiments should be considered from an illustrative rather than a restrictive perspective. The scope of the present invention is not shown in the above description, but in the claims, and all differences within the scope equivalent thereto should be interpreted as being included in the present invention.

According to an embodiment of the present invention, accuracy of segmenting organs in a medical image including regions with complex or ambiguous boundaries can be improved significantly by using a Diffusion Transformer Segmentation (DTS) model. The DTS model may establish a more accurate diagnosis and treatment plan in the field of medical image application by capturing spatial relationships within the anatomical structure and emphasizing object boundaries between adjacent structures or backgrounds.

In addition, the present invention may increase efficiency by providing models of various formats such as CT, MRI, and lesion images, and contribute to ultimate advancement in the medical image analysis by promoting future research and development of medical imaging software in medical imaging practice.

It should be understood that the effects of the present invention are not limited to the effects described above, and include all effects that can be inferred from the configuration of the invention described in the description or claims of the present invention.

### DESCRIPTION OF SYMBOLS

100: Medical image segmentation apparatus
110: Image input unit
130: Processing unit
150: Prediction unit
170: Segmentation unit

### NATIONAL RESEARCH AND DEVELOPMENT PROJECTS THAT SUPPORTED THIS INVENTION

1. Project 1:
   Project Unique Number: 2710008526
Project Number: 2020-0-01789-004
   Ministry: Ministry of Science and ICT
   Managing (Specialized) Agency: Knowledge Science Research Center
   Project Title: University ICT Research Center Development Support Project
   Research Task Name: Development of High-Performance Knowledge System and Human Resource Training
   Executing Institution: Dongguk University
   Research Period: Jan. 1, 2024-Dec. 31, 2024
2. Project 2:
   Project Unique Number: 2710008160
   Project Number: 00254592
   Ministry: Ministry of Science and ICT
   Managing (Specialized) Agency: Institute of Advanced Intelligence
   Project Title: AI Convergence Innovation Talent Development
   Research Task Name: AI Convergence Innovation Talent Development
   Executing Institution: Dongguk University. Research Period: Jan. 1, 2024-Dec. 31, 2024

What is claimed is:

1. A medical image segmentation apparatus comprising:
an image input unit for inputting a medical image;
a processing unit for embedding the input image into two encoders;
a prediction unit for inputting the embedded image into a decoder to predict a global feature map; and
a segmentation unit for segmenting the predicted feature region into regions of accurate organ locations.

2. The apparatus according to claim 1, wherein the processing unit calculates the input image and a pre-labeled image, divides the images in units of patches, and performs embedding.

3. The apparatus according to claim 1, wherein the processing unit performs partial reconstruct prediction of a feature representation learning part by encoding anatomical information of a human body by applying self-supervised learning (SSL) to the input image.

4. The apparatus according to claim 1, wherein the prediction unit generates a global feature map by applying a diffusion decoder.

5. The apparatus according to claim 1, wherein the segmentation unit pays attention to incorrectly predicted regions using a Reverse Boundary Attention (RBA) module.

6. A medical image segmentation method comprising steps of:
inputting a medical image;
embedding the input image into two encoders;
inputting the embedded image into a decoder to predict a global feature map; and
segmenting the predicted feature region into regions of accurate organ locations.

7. The method according to claim 6, wherein the step of embedding the input image into two encoders calculates the input image and a pre-labeled image, divides the images in units of patches, and performs embedding.

8. The method according to claim 6, wherein the step of embedding the input image into two encoders performs partial reconstruct prediction of a feature representation learning part by encoding anatomical information of a human body by applying self-supervised learning (SSL) to the input image.

9. The method according to claim 6, wherein the step of inputting the embedded image into a decoder to predict a global feature map generates a global feature map by applying a diffusion decoder.

10. The method according to claim 6, wherein the step of segmenting the predicted feature region into regions of accurate organ locations pays attention to incorrectly predicted regions using a Reverse Boundary Attention (RBA) module.

11. A computer program for executing the medical image segmentation method of claim 6 and recorded on a computer-readable recording medium.
